(19) United States
(12) Patent Application Publication
(10) Pub. No.: US 2013/0091020 A1
(43) Pub. Date: Apr. 11, 2013

(54) SYSTEM AND METHOD FOR ENABLING REVENUE FROM ADVERTISERS TO PUBLISHERS IN AN AD NETWORK

(71) Applicant: Srinivasan Raman, Cupertino, CA (US)

(72) Inventor: Srinivasan Raman, Cupertino, CA (US)

(73) Assignee: EBAY INC., SAN JOSE, CA (US)

(21) Appl. No.: 13/610,211

(22) Filed: Sep. 11, 2012

Related U.S. Application Data
(60) Provisional application No. 61/543,576, filed on Oct. 5, 2011.

(51) Int. Cl. G06Q 30/02

(52) U.S. Cl. 705/14.69

(57) ABSTRACT

A system and method for publisher controlled contextual commerce is disclosed. A particular embodiment includes obtaining publisher information corresponding to a plurality of publisher content items from a plurality of publisher sites; obtaining merchant information including value information corresponding to the plurality of publisher content items; using a processor, the publisher information, and the merchant information to generate a set of listings for transfer to the plurality of publisher sites, the set of listings each being ranked taking into account the value information of the merchant information; and allocating a merchant portion of revenue to publishers of the plurality of publisher sites, where the merchant portion of revenue corresponds to the value information of the merchant information.

### CROSS-REFERENCE TO RELATED APPLICATION

This application claims the benefit of U.S. Provisional Application No. 61/543,576, filed Oct. 5, 2011, which application is incorporated herein by reference in its entirety.

### TECHNICAL FIELD

This application relates to a method and system for use with an electronic commerce system, according to one embodiment, and more specifically, for providing an ability for publishers to earn revenue from advertisers in an Ad Network.

### BACKGROUND

On-line commerce sites on a wide-area public network (e.g., the Internet) often share information regarding products or services for sale. For example, search engines (e.g. Google) will pull content from on-line commerce sites, advertising sites, and/or content sites that may have product/service information, listings, or advertising related to search terms entered by a user of the search engine. As a result, the search engines can receive content feeds from a variety of content sources.

Publishers, including conventional search engines, today typically integrate with an Advertising Network (Ad Network) to have advertisements (ads) show up on publisher web site pages for display to users who visit publisher sites. Typically, publisher sites get paid by the Ad Network either based on a number of impressions (CPM), clicks (CPC), or sales (CPS). However, conventional Ad Networks do not provide an opportunity for publishers to share in revenue streams from both the Ad Network and directly from the advertisers/merchants.

### BRIEF DESCRIPTION OF THE DRAWINGS

The various embodiments is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram illustrating an example embodiment of multiple network and marketplace applications, respectively, which are provided as part of a network-based marketplace;

FIG. 3 is a high-level entity-relationship diagram, according to an example embodiment, illustrating various tables that may be maintained within a database to support networking and marketplace applications;

FIG. 4 is a system diagram illustrating an example embodiment of the system in which a publisher controlled contextual commerce system of a particular embodiment can operate.

FIG. 5 is a block diagram illustrating an example embodiment of the components of an ad network engine of a particular embodiment;

FIG. 6 is a block diagram illustrating an example embodiment of the components of a revenue allocation module of a particular embodiment;

FIG. 7 is a processing flow chart illustrating an example embodiment of an ad network engine as described herein.

FIG. 8 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In one embodiment, a system and method for enabling revenue from advertisers to publishers in an ad network is disclosed. In various example embodiments, an Advertising (Ad) Network aims to simplify, facilitate, monetize, and improve the efficiency of the transfer of product/service information, listings, advertising, and related revenue from a host site, such as an Ad Network site, an on-line commerce site, an auction site, a publisher site, a merchant site, or other product/service or broker site. The various example embodiments also provide an opportunity for publisher sites to share in revenue streams from both an Advertising (Ad) Network and directly from the advertisers/merchants. A particular embodiment can use an application programming interface (API) that can make use of host site product search, purchase, payment, and other API's to provide advertisements (ads), listings, and payment options to e-commerce users in a more valuable listing and format. Targeted ads can be customized according to keyword data, historical user conversion data, user profile information associated with one or more consumers, and information related to particular products, listings, and/or advertisements.

In a particular example system embodiment, there can be many content or publisher sites such as PCWorld, DPReviews, etc., which offer expert reviews or other information related to products or services. Almost always, such sites offer a price comparison widget backed up by product comparison services such as Shopping.com, NextAg, PriceGrabber, etc., to show product availability and a price range to potential buyers. The various embodiments described herein enable such publishers that offer reviews or other produce/service information (on typically the latest products/services,) or other content, to get a dual revenue stream by showing highly relevant ads. In the example summarized below, a Host website (e.g., eBay Marketplace) can serve as the Product Ad Network.

The system of various embodiments enables the publishers to register as Affiliates with the Host (e.g., the Ad Network).

The system of various embodiments enables the publishers to register all the product identifiers (ids) for which the publishers have content at the Host.

The system of various embodiments enables the various merchants/sellers of products at the Host site to bid on a percent of the item sale price the merchant/seller can offer as a revenue-share portion to publishers, on a per product basis. Once publishers are set up as Affiliates, the publishers register their products, and merchants/sellers offer a revenue-share to the publisher, the following scenario is enabled by the various embodiments:
User A visits a Publisher site (e.g., this site could be PCWorld.com, or any such publisher site).
User A visits the review page for Digital Camera DC123, for example.
Publisher site requests the Host to send targeted ads for DC123 digital cameras.
The Host responds to the Publisher with targeted advertisements for DC123 digital cameras, based on criteria such as seller reputation, item price, item location, and a publisher revenue-share percentage, etc.
The targeted ads are presented to User A by the Publisher.
User A looks at the items showcased by the Publisher, clicks through the ads to the Host, and purchases one of the showcased items.
The Publisher is eligible for an Affiliate revenue portion from the Host, because the Publisher drove quality traffic to the Host. Quality traffic represents users who convert (e.g., click on or purchase an item from an ad).
The Publisher is also eligible for a merchant revenue share directly from the merchant who sourced the purchased item, as the traffic the Publisher drove to the Host resulted in a sale. The Affiliate revenue portion (i.e., the revenue portion transferred from the Host to the Publisher) is already provided in conventional systems. However, conventional systems do not provide a means for sharing a merchant revenue portion for payment to Publishers from Merchants who source items purchased by users via a click-through on the Publisher site. The various embodiments described herein provide the ability for Publishers to declare and register a product set for which Publishers will display targeted ads, define minimum bid specifications for merchants/sellers, enable merchants/sellers to bid for placement of merchant/seller ads on the Publisher site and enable Publishers to receive a merchant revenue portion from merchants who source items purchased via a click-through on the Publisher site.

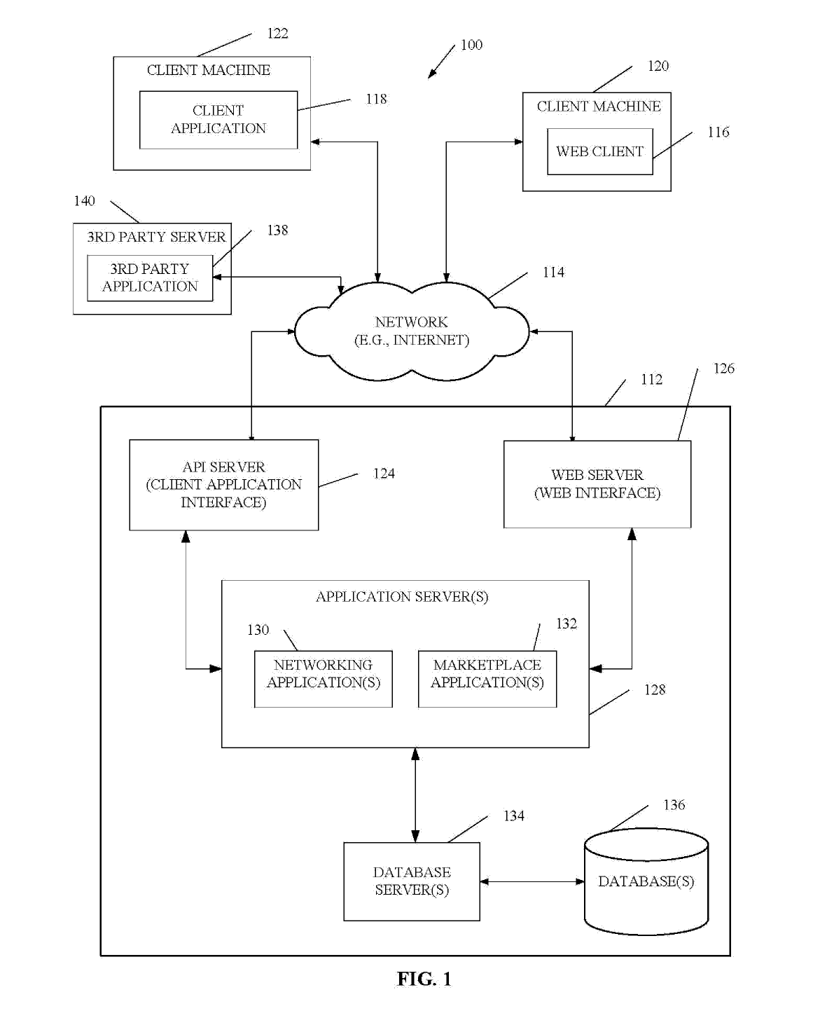

FIG. 1 is a network diagram depicting a network system 100, according to one embodiment, having a client-server architecture configured for exchanging data over a network. For example, the network system 100 may be a trading/commerce system where clients may communicate and exchange data with the trading/commerce system, the data may pertain to various functions (e.g., online purchases) and aspects (e.g., managing online transactions or network advertising) associated with the network system 100. Although illustrated herein as a client-server architecture for simplicity, in other embodiments the network architecture may vary and include an architecture such as a peer machine in a peer-to-peer (or distributed) network environment.

Returning to FIG. 1, a data exchange platform, in an example form of a network-based provider (or host system/site) 112, provides server-side functionality, via a network 114 (e.g., the Internet) to one or more clients. The one or more clients may include users that may utilize the network system 100 and more specifically, the network-based provider 112, to exchange data over the network 114. These transactions may include transmitting, receiving (communicating) and processing data to and from the multitude of users. The data may include, but is not limited to, user preference information, user profile information, advertisements (ads), product/service listings, ad or product identifiers, ad or product keywords, shopping or listing context information and/or identifiers, context data, notations (e.g., personal and public shopping notes), context filter data, shared electronic shopping carts, product and service reviews, product, service, manufacture, and vendor recommendations and identifiers, product and service listings associated with buyers and sellers, auction bids, feedback, etc. In one embodiment, the user profile information can be associated with one or more contexts generated by a user or other users and maintained on the network-based provider 112. Data associated with a user profile, such as any of the data described above, may be publicly shared as determined by the originator of the data.

Turning specifically to the network-based marketplace 112, an application program interface (API) server 124 and a web server 126 are coupled to, and provide programmatic and web interfaces respectively to, one or more application servers 128. The application servers 128 host one or more networking application(s) 130 and marketplace application(s) 132. The application servers 128 are, in turn, shown to be coupled to one or more databases servers 134 that facilitate access to one or more databases 136.

In one embodiment, the web server 126 may send and receive data pertaining to a user profile or item listing via a toolbar installed on a browser application. The toolbar may allow for a user or a third party to, inter alia, create a new user profile (a profile creator), selectively add a uniform resource locator (URL) associated with the created user profile, create notations regarding research and general matters associated with the user profile, and register an affiliate or publisher. In other embodiments, the web server may serve a page or the API server 124 in conjunction with the client application 118 may provide the same or similar functionality as that described with reference to the toolbar. It may be noted that using a toolbar within an application such as a browser or stand alone application is well known in the art.

The marketplace application(s) 132 may provide a number of marketplace functions and services (e.g., item listings, searching, advertisement, payment, etc.) to users that access the network-based marketplace 112. The networking application(s) 130 likewise may provide a number of consumer services, merchant services, or network advertising services and functions to users. The networking application(s) 130 may allow a user to generate one or more contexts related to shopping or advertisement (ad) generation, which may include listings (e.g., for products and services) couched as a broad category associated with a consumer, a class of consumers, and/or an item (e.g., a product or service or a listing for a product or service) or class of items. Additionally, listings can be couched as associated with a specific consumer or a specific item. For example, listings in the form of a category could be, “digital cameras” or “plumbers.” Similarly, a context can include a user profile associated with a category of users or a specific user. For example, a user profile in the form of a category could be, “women over 40 years old” or “purchasers of digital cameras.” An example of a user profile in a more specific form may be, “a user profile for John A. Smith of Akron, OH” or “purchasers of Canon digital cameras.” The level of specificity may vary and is selectable by the user profile creator or administrator of the Ad Network of a particular embodiment. For example, the user profile can be as specific as a particular person or the associated listing associated with a make, model, additional specific attributes or features of a specific item or service offered for sale or lease.

In one embodiment, the networking application(s) 130 and marketplace application(s) 132 may provide a client (e.g., web client 116) with an interface that includes input fields for personality or item/listing attributes most commonly selected by other users as the most important or most determinative attributes related to the products/services which a user/consumer is seeking or selling. For example, a multitude of users may have indicated they thought the most important personality attributes for the user profile include information related to: 1) consumer/user need, 2) general consumer/user personality, 3) consumer/user shopping attitude, and 4) consumer/user budget. A multitude of other users may have indicated they thought the most important item attributes for a digital camera purchaser user profile include: 1) digital camera brand, 2) pixel count, 3) zoom, and 4) size. These user profile attributes may be independently developed or discovered by the network-based marketplace 112 by processing the attribute data received from the multitude of users or may be based on the user profile creator ranking the attributes or a combination thereof.

The networking application(s) 130 may allow distribution of one or more user profiles to one or more groups defined by the user profile creator (e.g., “my family,” “my friends,” etc.) or to groups at various levels in a predefined category (e.g., “photography group,” “digital camera group,” or “Canon digital camera group,” etc.).

While the networking application(s) 130 and the marketplace application(s) 132 are shown in FIG. 1 to form part of the network-based marketplace 112, it will be appreciated that, in alternative embodiments, the networking application(s) 130 may form part of a networking service that is separate and distinct from the network-based marketplace 112.

FIG. 1 also illustrates a third party application 138, executing on a third party server machine 140, as having programmatic access to the network-based marketplace 112 via the programmatic interface provided by the API server 124. For example, the third party application 138 may, utilizing information retrieved from the network-based marketplace 112, support one or more features or functions on a website hosted by the third party. The third party website may, for example, provide one or more networking, marketplace or payment functions that are supported by the relevant applications of the network-based marketplace 112.

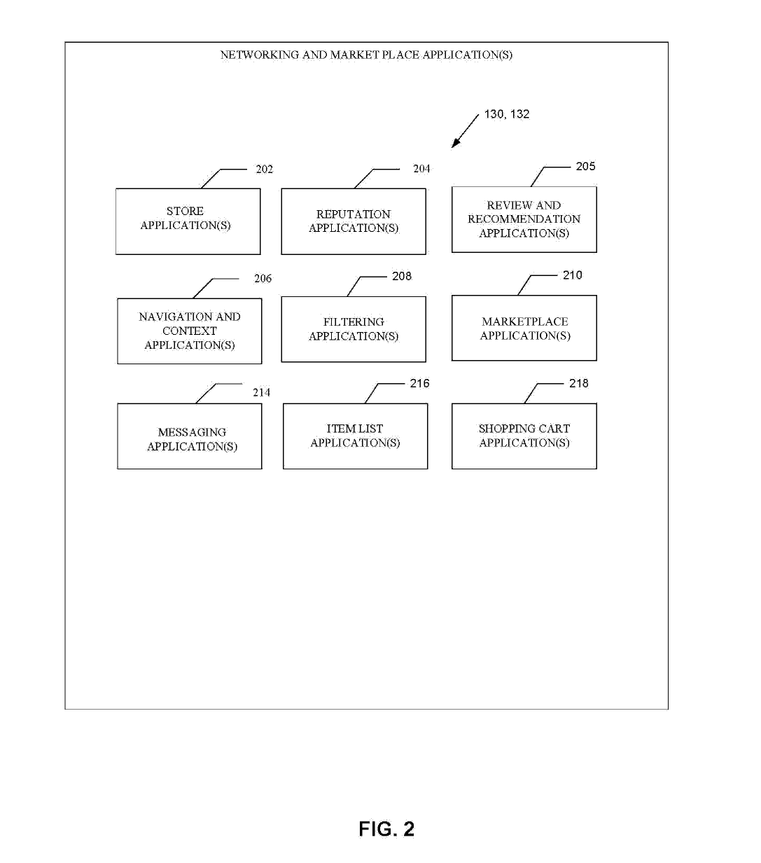

FIG. 2 is a block diagram illustrating an example embodiment of multiple network and marketplace application(s) 130 and 132, respectively, which are provided as part of the network-based marketplace 112. The network-based marketplace 112 may provide a number of listings for goods and/or services, category-based shopping, network advertising, and purchase and bidding systems, various levels of features provided for users, and price-setting mechanisms whereby a seller may list goods and/or services (e.g., for sale, bid, or lease) and a buyer may buy or bid on listed goods and/or services. A user profile and context associated with a user shopping or listing an item in the network-based marketplace 112 may offer or provide information that may be helpful in assisting the user in customizing their shopping or listing experience pertaining to the user profile or listing information (i.e., context). Among various embodiments, the recommendations, reviews, or research notes corresponding to the user profile or listing information may be directed from another user to one or more users desiring data associated with the user profile or listing information or the data may be provided from storage by the network and marketplace application(s) 130 and 132 based on the user profile or listing information provided by a user. The data may be provided based on a request from the user or automatically pushed to the user based on policy or a user configuration file.

To this end, the network and marketplace application(s) 130 and 132, respectively, are shown to include one or more application(s) which support the network-based marketplace 112, and more specifically the generation and maintenance of one or more user profiles provided by users of the network-based marketplace 112 or other users. These applications can include support for activities associated with the user profiles and listing information, including storing and retrieving user notes, web sites (URLs), links associated with related tags, research and notes from other users and community members, related community groups, vendors, providing localized geographic data for user profiles (e.g., regional or country-specific consumer purchasing patterns), etc. Additionally, the various applications may support other networking functions, including building and maintaining the community groups created by a user, which may be helpful in providing various types of data (e.g., reviews, notes, local services, consumer information, etc.) pertaining to the user profiles and listing information.

Store application(s) 202 may allow sellers to group their listings (e.g., goods and/or services) within a “virtual” store, which may be branded and otherwise personalized by and for the sellers. Such a virtual store may also offer promotions, incentives and features that are specific and personalized to a relevant seller and consumer. In one embodiment, based on the user profiles provided by the user, the virtual store may be provided to the user or Ad Network user where the virtual store may carry or sell an item or service related to a user's need based on the user profile.

Reputation application(s) 204 may allow parties that transact utilizing the network-based marketplace 112 to establish, build, and maintain reputations, which may be made available and published to potential trading partners. Consider that where, for example, the network-based marketplace 112 supports person-to-person trading, users may have no history or other reference information whereby the trustworthiness and/or credibility of potential trading partners may be assessed. The reputation application(s) 204 may allow a user, for example through feedback provided by other transaction partners, to establish a reputation within the network-based marketplace 112 over time. Other potential trading partners may then reference such a reputation for the purposes of assessing credibility, trustworthiness, or the like. A user seeking reviews, research (e.g., notes, etc.), and recommendations associated with the product/service may filter the result data from the search or context submission based on reputation data. For example, the user may only want product/service data such as reviews and research notes pertaining to the product/service data with a greater than 3 out of 5 star reputation rating.

In one embodiment, the network-based marketplace 112 includes review and recommendation application(s) 205. The marketplace application(s) 210 may work in conjunction with the review and recommendation application(s) 205 to provide a user interface to facilitate the entry of reviews of the product/service data received from other users. A review may be a text entry of the community group member's opinion, a standard review form including check boxes indicating a level satisfaction, or a combination of both, etc. Recommendations may include a specific type of demographic, item, a specific brand or service for a type of item, a specific retailer for the item, etc.

Navigation of the network-based marketplace 112 may be facilitated by one or more navigation and context application(s) 206. For example, a context application may, inter alia, enable key word searches of item listings associated with a context defined by a user profile of a particular consumer. The context can include an association between the user profile data in the user profile and item feature sets related to items in the item listings. The item listings can include listings from a group including products or services or both. The item feature set data and data defining the association between the user profile data in the user profile and item feature sets may be retrieved from the network-based marketplace 112 (e.g., databases 136) or from various other remote sources, such as other network sites, other users (e.g., experts or peers), etc. In one embodiment, a toolbar installed on a browser application may be used for functions including interactive and navigation functions to create ads and product/service information, selectively add a uniform resource locator (URL) associated with a product/service offered for sale, and create notations regarding research and general matters associated with the product/service. These functions may be user accessible by many methods known in the art, including a web form interface (HTML or embedded Java) or a stand-alone application interface. For example, a navigation application may include a browser that allows users via an associated user interface to browse a user's user profile, various item listings, item feature sets, contexts, catalogues, inventories, online marketplaces, and review data structures within the network-based marketplace 112. In one embodiment, the user interface includes selectable elements in the form of tabs to separate out various categories of listing or user profile data that when selected generate a list associated with the category. For example, a tab for “My Notes,” a tab for “Everyone's Notes,” a tab for “Buy,” and a tab for “Sell”. Various other navigation applications (e.g., an external search engine) may be provided to supplement the search and browsing applications.

In one embodiment, using filtering application(s) 208, the user or the Ad Network may customize result data associated with a user profile or listing search results. The filtering application(s) 208 may generate the result data according to one or more rules provided by the network-based marketplace 112 and the user receiving the filtered result data. For example, as discussed above with reference to the reputation application(s) 204, the user may only want a query to match on item listings pertaining to item reviews from other users with a greater than 3 out of 5 star reputation rating. In another example, the user may only want a query to match on item listings pertaining to item listings with a particular feature set or attribute set. For example, the user may only want result data for digital cameras with equal or greater than 5 megapixels. Additionally, the filtering rules may be combinable or modifiable to broaden or narrow the scope of the result data. The filtering application(s) 208 may also be used to implement rules for granting or allowing access to the user profile data.

Messaging application(s) 214 may be used for the generation and delivery of messages to users of the network-based marketplace 112. For example, the user may like a particular review or research from another user and may wish to contact the user for additional information. In one embodiment, the messaging application(s) 214 may be used in conjunction with the marketplace application(s) 210 to provide promotional and/or marketing (e.g., targeted advertisements associated with a product/service) to the user or a related user from vendors and community members that may have offerings related to the user profile.

Item list application(s) 216 may be used in the network-based marketplace 112 by the user to create an item list based on selecting one or more items and services to purchase (or sell, auction, lease, or donate), which may be at least partially based on result data associated with the user's shopping experience. The item list application(s) 216 may be accessed via a user interface that allows the user to create and use the item list. Additionally, the user may selectively share this list within a community or to all users to gain or solicit additional data such as vendor recommendations for each purchase or vendor reviews for vendors that may be present in the list.

In one embodiment, electronic shopping cart application(s) 218 are used to create a shared electronic shopping cart used by a user to add and store items from a shopping list generated by the user (e.g., by making selections from a “Buy” tab). The electronic shopping cart application(s) 218 may facilitate the transactions for each item on the list by automatically finding the items in the electronic shopping cart across at least one or all of a set of vendors, a comparison shopping site, an auction site, other user's ads, etc. In one embodiment, a multitude of transactions may appear as one transaction based on the selection of “Bulk Purchase.” In various embodiments, the selection criteria for which vendor or vendors to purchase from may include, but is not limited to, criteria such as lowest cost, fastest shipping time, preferred or highest rated vendors or sellers, or any combination thereof.

It will be appreciated that one or more of the various sample networking and marketplace application(s) 130, 132 may be combined into a single application including one or more modules. Further, in some embodiments, one or more applications may be omitted and additional applications may also be included.

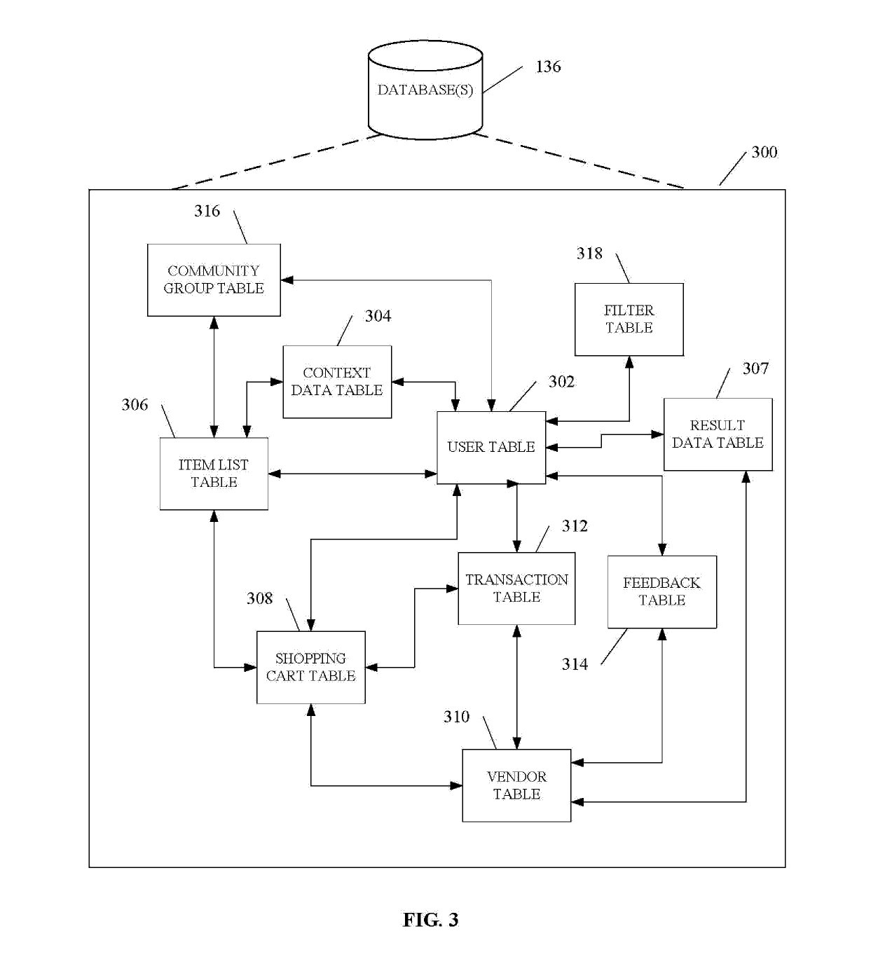

FIG. 3 is a high-level entity-relationship diagram, in accordance with an example embodiment, illustrating various tables 300 that may be maintained within the database(s) 136 (see FIG. 1), which may be utilized by and support the networking and marketplace application(s) 130 and 132, respectively. A user table 302 may contain a record for each registered user of the network-based marketplace 112, and may include identifier, address and financial instrument information pertaining to each such registered user. In one embodiment, a user operates as one or all of a user profile creator, a seller, a buyer, within the network-based marketplace 112.

The context data table 304 maintains a record of the one or more user profiles and/or listings created by or related to a user. As discussed above, this may include user profile identifiers and/or listing identifiers that may include words and/or phrases from the general to the specific for a consumer class, specific consumer, product/service class, or a specific product/service. Context data in context data table 304 can also include associations between the user profile data in the personalized consumer profiles and item feature sets related to items in the item listings. The item listings can be listings for products or services or both. The personalized consumer profiles, item feature set data, and data defining the association between the user profile data in the personalized consumer profiles and item feature set data may be stored into or retrieved from the context data table 304 of database(s) 136. In one embodiment, each word in a phrase may be a tag linked to another user profile and its associated data. For example “Canon” may be a selectable element within the user interface as a tag that results in the selector receiving more general data regarding Canon products. Similarly, “camera” may be selected to receive more general data regarding cameras, in this case both digital and film cameras.

The tables 300 may also include an item list table 306 which maintains listing or item records for goods and/or services that were created using the item list application(s) 216. In various embodiments, the item list may be created and shared with a community group or to all users in part to solicit feedback regarding listed or potential vendors.

Each listing or item record within the item list table 306 may furthermore be linked to one or more electronic shopping cart records within a electronic shopping cart table 308 and to one or more user records within the user table 302 and/or a vendor table 310, so as to associate a seller or vendor and one or more actual or potential buyers from the community group with each item record.

A transaction table 312 may contain a record for each transaction pertaining to items or listings for which records exist within the item list table 306. For example, the transaction table 312 may contain a purchase or sales transaction of an item of the item list by a consumer.

In one example embodiment, a feedback table 314 may be utilized by one or more of the reputation application(s) 204 to construct and maintain reputation information associated with users (e.g., members of the community group, sellers, etc.).

Group(s) of users found in a community group table 316 may be selected by a user to be members of a community group having access to user profile data and an item listing associated with the electronic shopping cart.

A filter table 318 may be used to sort and filter data associated with an item listing or a user profile. The sorted or filtered data are then stored in the result data table 307 and linked to the listing or user profile creator via a user profile identifier. Various types of filters and associated rules were discussed above with reference to the filtering application(s) 208 in FIG. 2.

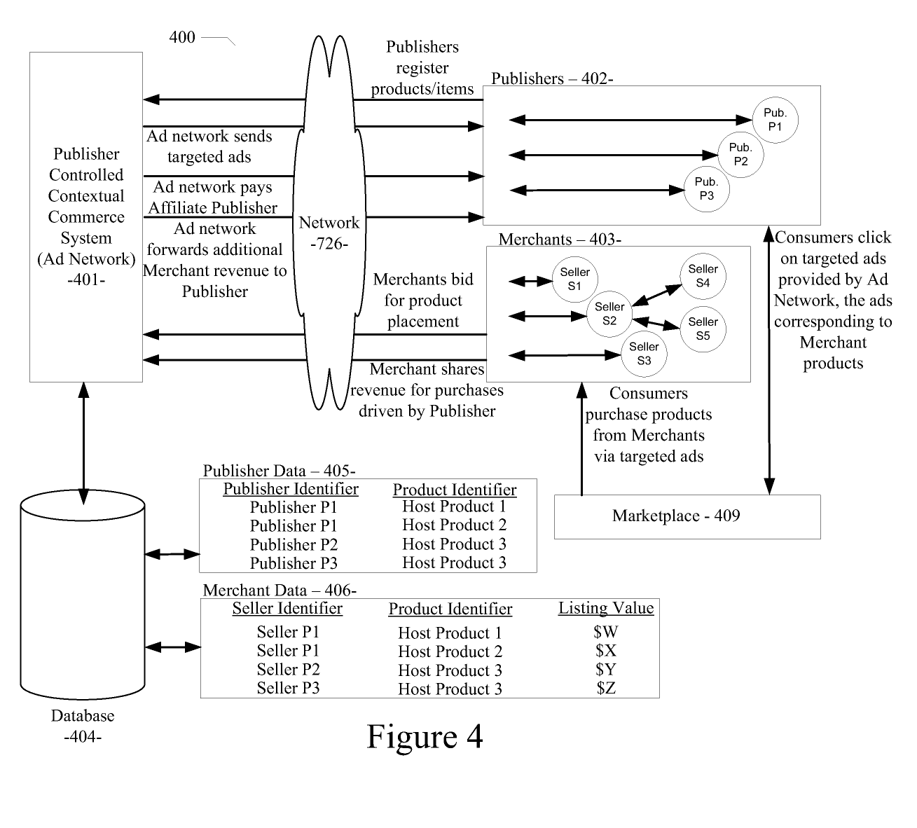

FIG. 4 is a system diagram illustrating an example embodiment 400 of the system in which a publisher controlled contextual commerce system (Ad Network) 401 of a particular embodiment can operate. As shown, the Ad Network 401 can communicate via a network 726 with a plurality of publisher sites 402 and a plurality of merchant or seller sites 403. In one embodiment, the Ad Network 401 can collect affiliate data and product/item registration data from the publisher sites 402 and product/item placement bid data from the merchant sites 403. The publisher sites 402 can also convey to the Ad Network 401, information related to product keywords or product identifiers that correspond to the product information appearing in a particular publisher's content on the Ad Network 401 site. In this manner, publisher sites 402 can register products/items with the Ad Network 401. Using this information, the Ad Network 401 can generate a Publisher data set 405. For example, the Ad Network 401 can obtain a host product identifier corresponding to each registered product/item. The Publisher data set 405 can be used by the Ad Network 401 to store information related to the connections or relationships between host product identifiers and the identifiers of the corresponding publishers or publisher sites. An example of the content of the Publisher data set 405 for an example embodiment is shown in FIG. 4.

Similarly, the Ad Network 401 can collect product/item placement bid data or value offers from the merchants 403. For example, merchants 403 can bid on product keywords or product identifiers that correspond to their products/items. These merchant bids or merchant product/item value information can be conveyed to the Ad Network 401 via network 726. Using this merchant bid information, the Ad Network 401 can generate a Merchant data set 406. The Merchant data set 406 can be used to store merchant bids corresponding to host product identifiers. An example of the content of the Merchant data set 406 for an example embodiment is shown in FIG. 4. As described in more detail below, the merchant bids can be used by the Ad Network 401 to facilitate the placement of product/item listings at publisher sites 402 taking into account the value of each merchant bid.

Referring still to FIG. 4, the system of various embodiments enables the publishers to register as Affiliates with the Host (e.g., the Ad Network 401). The system of various embodiments enables the publishers to register all product identifiers (ids) for which the publishers have content, at the Host 401. The system of various embodiments also enables the various merchants/sellers of products to bid a portion of the item sale price the seller can offer as a merchant revenue-share portion to publishers, on a per product basis. Once publishers are set up as Affiliates with the host 401, the publishers register their products with Host 401, and merchants/sellers have placed product placement bids with the Host 401 to offer a merchant revenue-share to the publishers, the following scenario is enabled by the various embodiments as shown in FIG. 4:

User A from Marketplace 409 visits a Publisher site 402.

User A visits the review page for Digital Camera DC123 shown on a page of a Publisher site 402.

Publisher site 402 requests the Host 401 to send targeted ads for DC123 digital cameras to the publisher site 402.

The Host 401 responds to the Publisher 402 with targeted advertisements for DC123 digital cameras, based on criteria such as seller reputation, item price, item location, and a publisher revenue-share percentage, etc. The Host 401 can arrange or sort the targeted advertisements sent to the Publisher 402 based on a variety of criteria including the product placement bid placed by a merchant 403. Higher value bids from a Merchant 403 may result in a more favorable positioning of ads for the Merchant 403 in the set of targeted ads sent to the Publisher 402 by the Host 401.

The targeted ads are presented to User A of Marketplace 409 by the Publisher 402.

User A looks at the items showcased in the targeted ads displayed by the Publisher 402, clicks through the ads to the Host 401, and purchases one of the showcased items sourced by a particular Merchant 403.

The Publisher 402 is eligible for an Affiliate revenue portion from the Host 401, because the Publisher 402 drove quality traffic to the Host 401 via the targeted ad. Quality traffic represents users who convert (e.g., click on or purchase an item from an ad).

The Publisher 402 is also eligible for a merchant revenue share directly from the Merchant 403 who sourced the purchased item, as the traffic the Publisher 402 drove to the Host 401 resulted in a sale for the merchant. The Affiliate revenue portion (i.e., the revenue share transferred from the Host 401 to the Publisher 402) is already provided in conventional systems. However, conventional systems do not provide a means for sharing a merchant revenue portion for payment to Publishers 402 from Merchants 403 who source items purchased via a click-through on the Publisher 402 site. The various embodiments described herein provide the ability for Publishers 402 to declare and register a product set for which the Publisher 402 will display targeted ads, define minimum bid specifications for Merchants/sellers 403, enable Merchants/sellers 403 to bid for placement of Merchant/seller 403 ads on the Publisher 402 site and enable Publishers 402 to receive a merchant revenue portion via Host 401 from Merchants 403 who source items purchased via a click-through on the Publisher site.

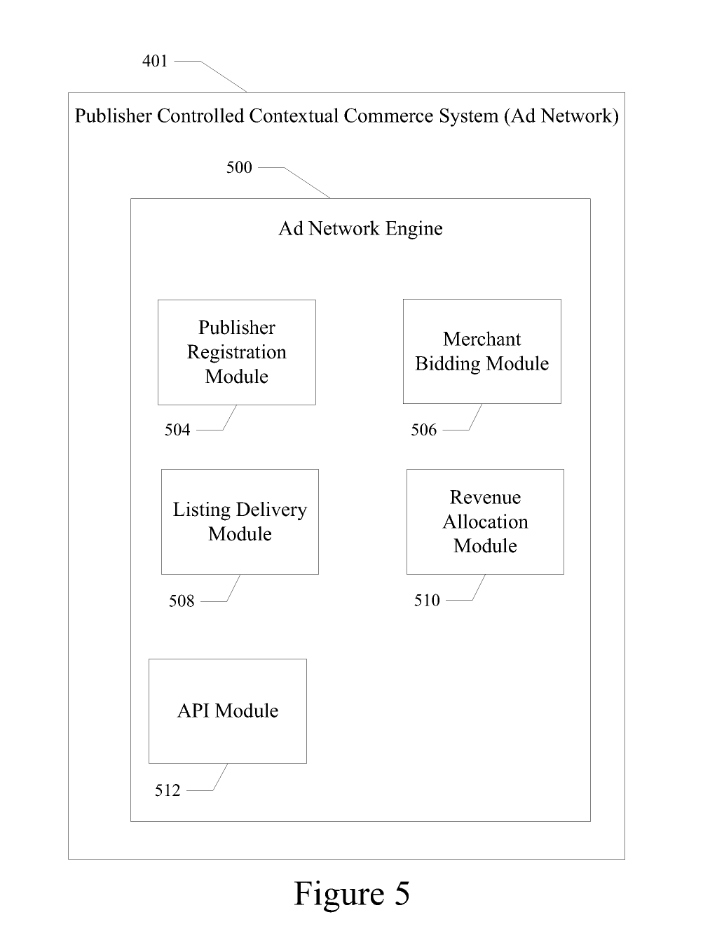

FIG. 5 illustrates an example embodiment of functional modules or tools pertaining to the ad network engine 500 of a particular embodiment. It will be appreciated that the applications and associated modules may be executed within any portion of the network system 100, (e.g., the server machine 112). Additionally, the modules discussed herein are for example only and it can be appreciated these modules and applications may be combined into one or many modules and applications without departing from the scope of the methods and systems described herein.

In the particular embodiment, the Ad Network 401 may include an ad network engine 500. The ad network engine 500 of a particular embodiment, as shown in FIG. 5, can include a number of features, applications, services, tools, or modules, such as:

Publisher Registration Module 504—Collection of publisher product/item registration data.

Merchant Bidding Module 506—Collection of merchant product placement bids.

Listing Delivery Module 508—Transfer of the targeted ads or item listings to corresponding publishers.

Revenue Allocation Module 510—Allocation and transfer of value from the Ad Network to Affiliate Publishers and the allocation and transfer of value from the Merchants via the Ad Network to Publishers.

API Module 512—APIs for the publisher controlled contextual commerce service.

These ad network engine 500 modules of a particular embodiment are described in more detail below.

In a particular embodiment, the database 404 can include the following elements:
The database 404 can be used to store data for the Ad Network 401 application.
The database 404 can have tables to store all data posted by the features described herein.
The database 404 can include a Publisher data set 405, which includes information related to the connections or relationships between products or items appearing in a particular publisher's content and the identifiers of the corresponding publisher sites.
The database 404 can include a Merchant data set 406, which includes information related to the connections or relationships between products or items appearing in a particular publisher's content, the identifiers of the corresponding publisher sites, the merchant bids corresponding to the particular products/items, and the merchant or seller associated with each bid.

Although an example embodiment is shown herein with a database 404, the database 404 can be originally created or existing product databases, product catalogs, or existing inventory lists can also be used with the systems described herein.

### Publisher Registration Module 504

When a publisher site 402 uses APIs provided by API module 512 to register particular products or items with the Ad Network 401, the Publisher Registration Module 504 receives this data from the publisher site 402 and updates the corresponding portions of the publisher data set 405 in database 404. The Publisher Registration Module 504 can also augment the data stored in publisher data set 405 with data retrieved from other sources. For example, additional product information, related product keyword or product identifier information, or other information related to a product/item registered by a publisher site 402 can also be added to the publisher data set 405 by the Publisher Registration Module 504.

### Merchant Bidding Module 506

A merchant site 403 can use APIs provided by API module 512 to bid for placement of ads or listings for particular products or items with the Ad Network 401. The Merchant Bidding Module 506 can receive merchant data including merchant bids or value offerings from a merchant site 403. The Merchant Bidding Module 506 updates the corresponding portions of the merchant data set 406 in database 404. The Merchant Bidding Module 506 can also augment the data stored in merchant data set 406 with data retrieved from other sources. For example, additional product information, related product keyword or product identifier, related bid or purchase information, publisher information, item value or bid value information, or other information related to a bid submitted by a merchant site 403 can also be added to the merchant data set 406 by the Merchant Bidding Module 506. The Merchant Bidding Module 506 can enable merchants/sellers at merchant sites 403 to bid for placement of merchant/seller ads on the Publisher sites 402. The Merchant Bidding Module 506 can also enable merchants/sellers at merchant sites 403 to bid for a portion of an item sale price, on a per product basis, the merchants/sellers can offer as a merchant revenue share to publishers at the Publisher sites 402 for driving traffic to the merchant/seller sites 403.

### Listing Delivery Module 508

The Listing Delivery Module 508 can use the publisher data and merchant data to configure a set of listings or advertisements for delivery to publishers 402. The Listing Delivery Module 508 can have access to a pool of available listings stored in database 404 or accessible via a network 726 access. The Listing Delivery Module 508 can scan or cull the pool of available listings for listings that match the product criteria provided by Publishers 402 when the publishers registered with the Ad Network 401. The Listing Delivery Module 508 can also rank the matching listings taking into account the merchant data corresponding to the product criteria associated with the matching listings. The merchant data can include a seller identifier, a product identifier, and bids or offers of value for placement of merchant/seller ads on the Publisher sites 402. An example of this merchant data 406 is illustrated in FIG. 4. Additional merchant data can include a geographic location of sellers, a rating or merchant score associated with sellers, history of transactions or activity by particular sellers, and the like. The Listing Delivery Module 508 can use all of this merchant data to rank the matching listings into an order for delivery to particular publishers at Publisher sites 402. As a result of this culling and ranking operation performed by the Listing Delivery Module 508, a merchant who bid highly for a particular listing placement might expect to have the merchant's listing or advertisement prominently displayed for users of Publisher sites 402.

### Revenue Allocation Module 510

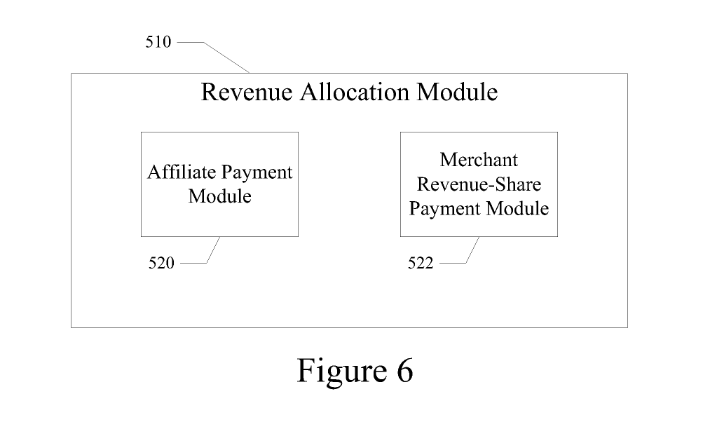

The Revenue Allocation Module 510 can use the set of ranked listings, the publisher data 405, and the merchant data 406 to allocate and transfer value to publisher sites 402. The Revenue Allocation Module 510 can be a web application. In a particular embodiment, the Revenue Allocation Module 510, as shown in FIG. 6, can include a number of features, applications, services, tools, or modules, such as:
Affiliate Payment Module 520
Merchant Revenue-Share Payment Module 522

These Revenue Allocation Module 510 components of a particular embodiment are described in more detail below.

### Affiliate Payment Module 520

The Affiliate Payment Module 520 handles the allocation and payment of an affiliate revenue portion from the Ad Network 401 to the Affiliate Publishers 402. In a manner similar to conventional on-line advertising systems, the Ad Network 401 tracks the listings or ads that are delivered to the various Publisher sites 401, tracks user views (impressions) or activations (conversions) of these listings or ads, and allocates an affiliate revenue portion for the Affiliate Publishers 402, which host a listing or ad viewed and/or converted by a user at the Publisher site 402. In this manner, the Publisher site 402 is said to have driven user traffic to a network location corresponding to the listing or ad (e.g., a merchant site sourcing items featured in the viewed or converted listing or ad). The affiliate revenue portion paid to an Affiliate Publisher 402 by the Ad Network 401 compensates the Affiliate Publisher site 402 for driving this user traffic. As shown in FIG. 4, the Ad Network 401 can pay the affiliate revenue portion to the Affiliate Publisher 402 via network 726.

### Merchant Revenue-Share Payment Module 522

The Merchant Revenue-Share Payment Module 522 handles the allocation and payment of a merchant revenue portion from the Merchants 403 to the Publishers 402. The Merchant Revenue-Share Payment Module 522 can use the merchant data set 406 to determine a listing value associated with a particular listing or ad that was bid by a particular merchant of merchant sites 403. Additionally, as described above, the Ad Network 401 tracks the listings or ads that are delivered to the various Publisher sites 401 and tracks user views (impressions) or activations (conversions) of these listings or ads. Using the listing impression/conversion data in combination with the merchant data 406, the Merchant Revenue-Share Payment Module 522 can allocate a merchant revenue portion for the Publishers 402, which host a listing or ad viewed and/or converted by a user at the Publisher site 402, where the viewed and/or converted ad was the subject of a bid by a merchant at merchant site 403. In this manner, the Publisher site 402 has driven user traffic to a network location corresponding to a particular merchant who bid on the viewed/converted listing or ad. The merchant revenue portion paid to a Publisher 402 by a Merchant site 403 via the Ad Network 401 compensates the Publisher site 402 for driving this user traffic to the bidding merchant. As shown in FIG. 4, the Merchant site 403 can pay the merchant revenue portion to the Publisher 402 via the Ad Network 401 and network 726.

### Application Programming Interface (API) Module 512

All APIs supported by the API module 512 can be based on a Service Oriented Architecture. When responding to a “post” request by the client, the API can write data into a database table and reply back to the client with success or failure codes. As described above, a publisher site 402 can use APIs provided by API module 512 to register particular products or items with the Ad Network 401. Similarly, a merchant site 403 can use APIs provided by API module 512 to submit a bid related to particular products or items to the Ad Network 401. The APIs provided by API module 512 can also be used by the Ad Network 401 to transfer targeted advertising or product/item listings to the publisher sites 402. The APIs provided by API module 512 can also be used by the Ad Network 401 to transfer value from the Ad Network 401 to the Affiliate Publishers 402 and to transfer value from Merchants 403 to Publishers 402.

### Sample Operation of an Example Embodiment

In the sample operational sequence set forth below, the Ad Network 401 handles the communication and coordination between a plurality of Publisher sites 402 and a plurality of Merchant sites 403. The Ad Network 401 of various embodiments enables the Publishers 402 to register as Affiliates with the Host (e.g., the Ad Network 401). The Ad Network 401 of various embodiments enables the Publishers 402 to register all the product identifiers (ids) for which the publishers have content at the Host. The Ad Network 401 of various embodiments enables the various merchants/sellers at Merchant sites 403 to bid on a portion of an item sale price the merchant/seller can offer as a revenue-share portion to Publishers 402, on a per product basis. Once Publishers 402 are set up as Affiliates, the Publishers 402 register their products, and merchants/sellers of Merchant sites 403 have provided bids for a merchant revenue-share to the publisher as described above, the following sequence of events is enabled by the various embodiments:

User A visits a Publisher site 402 (e.g., this site could be PCWorld.com, or any such publisher site).

User A visits the review page for Digital Camera DC123.

Publisher site 402 requests the Host (e.g., Ad Network 401) to send targeted ads for DC123 digital cameras.

The Host 401 responds to the Publisher 402 with targeted advertisements for DC123 digital cameras, based on criteria such as seller reputation, item price, item location, and a publisher revenue-share percentage, etc.

The targeted ads are presented to User A by the Publisher 402.

User A looks at the items showcased by the Publisher 402, clicks through the ads to the Host 401 (converts on the ad), and purchases one of the showcased items.

The Publisher 402 is eligible for affiliate revenue from the Host 401, because the Publisher 402 drove quality traffic to the Host 401. Quality traffic represents users who convert (e.g., click on or purchase an item from an ad).

The Publisher 402 is also eligible for a revenue share directly from the Merchant 403 who sourced the purchased item, as the traffic the Publisher 402 drove to the Host 401 or Merchant 403 resulted in a sale and a revenue share for the merchant from the sale. The affiliate revenue portion (i.e., the revenue portion transferred from the Host 401 to the Publisher 402) is already provided in conventional systems. However, conventional systems do not provide a means for sharing a revenue portion for payment to Publishers 402 from Merchants 403 who source items purchased via a click-through on the Publisher site 402. The various embodiments described herein provide the ability for Publishers 402 to declare and register a product set for which the Publisher 402 will display targeted ads, define minimum bid specifications for merchants/sellers, enable Merchants/sellers 403 to bid for placement of merchant/seller ads on the Publisher site 402 and enable Publishers 402 to receive a merchant revenue portion from Merchants 403 who source items purchased via a click-through on the Publisher site and who bid on placement of related listings or ads.

As described herein, the Ad Network Engine 500 of an example embodiment provides the ability for publishers to register products the publishers showcase on their site. By registering a product, the Publisher 402 is eligible for a revenue share directly from the Merchant 403 who sourced the purchased item. Using the features provided by the Ad Network Engine 500 of an example embodiment, Publishers 402 also have the option to customize the presentation of product listings or ads on their site to define product relationships or product views on the Publisher site 402. For example, Publishers 402 can define product relationships for all products they showcase on their site in at least the following ways:

A product can be defined as a VARIANT of another product (e.g., iPad 16 GB, iPad 32 GB).

A product can be defined as NEXTGEN VARIANT of another product (e.g., iPad 16 GB, iPad2 16 GB).

A product can be defined as SIMILAR UPSALE to another product (e.g., iPod, iTouch).

A product can be defined as SIMILAR to another product (e.g., iPad, Samsung Galaxy).

A product can be defined as RELATED to another product (e.g., iPad, iPad Case).

By establishing these product relationships, the Publishers 402 can enable Merchants 403 to bid, not only on particular products, but also to bid on products as they appear on the Publisher site 402 in a desired relationship with other products. Merchant 403 bids for products can be in differing amounts depending on the relationship of the product bid on with related products. In this manner, Merchants 403 can maximize the likelihood of customer conversion on the Publisher site 402 and the Publisher 402 can maximize the revenue received from a particular merchant 403.

In a similar way, Publishers 402 can define product views on the Publisher site 402 and receive merchant 403 bids based on where on the Publisher site 402 a desired product is shown. For example, Publishers 402 can define product views on the Publisher site 402 as they showcase products on their site in at least the following ways:

Home Page

Primary Product Page

Additional Product Pages; or

Any remaining pages.

By establishing these product views, the Publishers 402 can enable Merchants 403 to bid, not only on particular products, but also to bid on products as they appear on the Publisher site 402 in a desired location on the Publisher site 402. Merchant 403 bids for products can be in differing amounts depending on the product view location on the Publisher site 402. As such, Merchants 403 can register different bids for product placement in a Home Page, a Primary Product Page, an additional product page, or other page of the Publisher site 402. In this manner, Merchants 403 can maximize the likelihood of customer conversion on the Publisher site 402 and the Publisher 402 can maximize the revenue received from a particular merchant 403.

As described herein, the Ad Network Engine 500 of an example embodiment also provides the ability for publishers to customize the association of Merchant product bids with corresponding product placements on the Publisher site 402 in a variety of other ways. For example, the Publisher 402 can get paid by merchants based on a number of impressions (CPM), clicks (CPC), sales (CPS), or any combination thereof occurring on the Publisher site 402. The Publisher 402 can also get paid by merchants based on a catch-all model wherein a sale occurred following a click on a Publisher site 402, but the sale was for a product other than any products on which the Merchant 403 placed a bid. In a particular embodiment, Merchants 403 can also override their bids for specific sites. In this manner, Merchants 403 can target different sites in different ways.

As described herein, the Ad Network Engine 500 of an example embodiment also provides the ability for Publishers 402 to make a request (e.g., via an API call) to the Ad Network 401 for a list of relevant listings from a Merchant 403 for a specified product. The returned list can also be ranked and/or filtered using a variety of ranking and filtering functions to produce a processed list with high-value listings. In a particular embodiment, the Publisher 402 can specify the particular ranking and filtering function(s) to be used by the Ad Network 401 to produce the processed list of high-value listings.

As described herein, the Ad Network Engine 500 of an example embodiment also provides the ability for Merchant 403 bids to be received indirectly through other Merchants 403. For example, a group of merchants can aggregate a group of product bids into a combined bid, which is submitted to the Publisher 402. In this manner, cascading levels of merchants can submit product bids alone or in groups with other merchants (e.g., see FIG. 4). As such, merchants 403 acting alone or merchants 403 acting in cooperation with other merchants 403 or other ad networks can submit bids to a Publisher 402 using the Ad Network Engine 500 of an example embodiment as described herein.

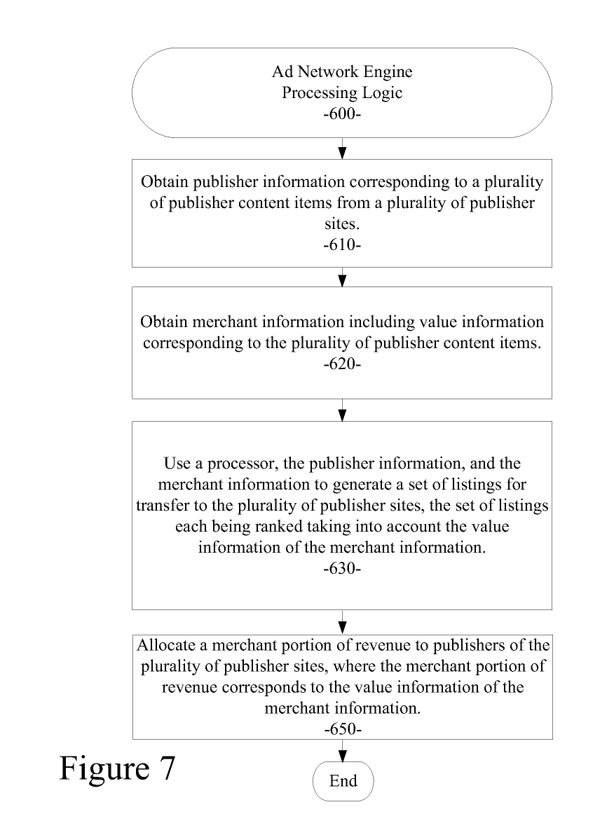

FIG. 7 is a processing flow chart illustrating an example embodiment 600 of an Ad Network engine 500 as described herein. The method of an example embodiment includes: obtaining publisher information corresponding to a plurality of publisher content items from a plurality of publisher sites (processing block 610); obtaining merchant information including value information corresponding to the plurality of publisher content items (processing block 620); using a processor, the publisher information, and the merchant information to generate a set of listings for transfer to the plurality of publisher sites, the set of listings each being ranked taking into account the value information of the merchant information (processing block 630); and allocating a merchant portion of revenue to publishers of the plurality of publisher sites, where the merchant portion of revenue corresponds to the value information of the merchant information (processing block 650).

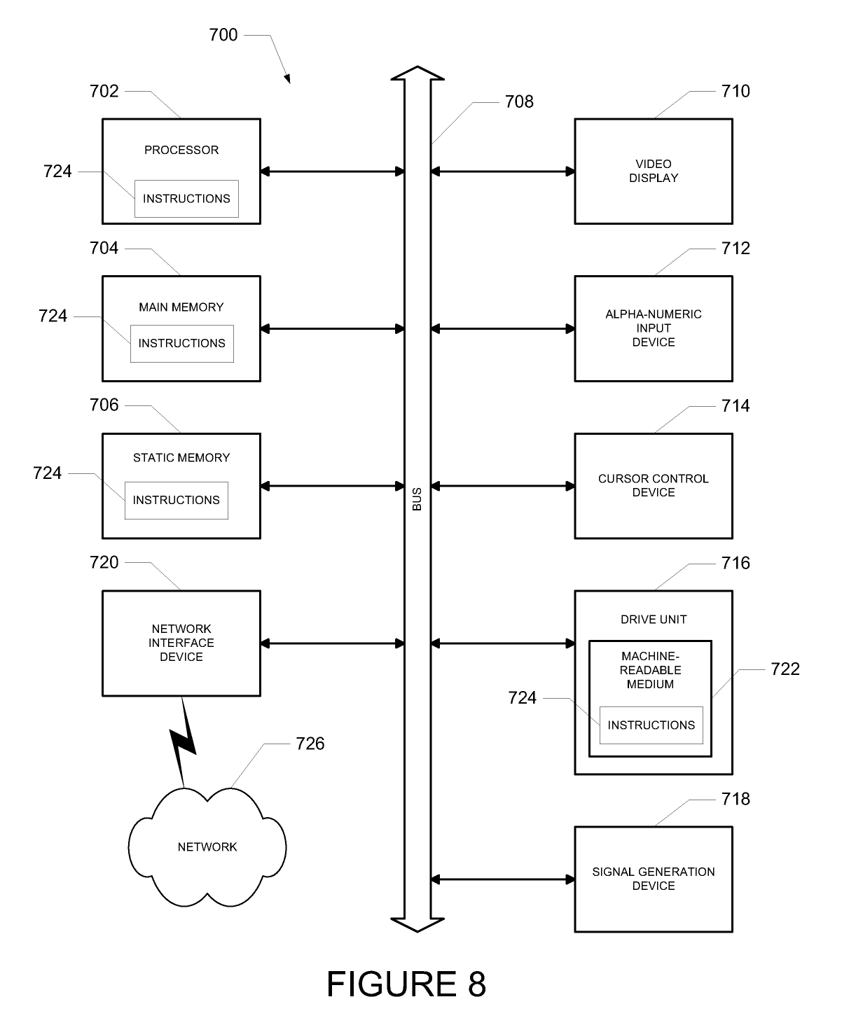

FIG. 8 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” can also be taken to include any medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

We claim:

1. A method, including:
obtaining publisher information corresponding to a plurality of publisher content items from a plurality of publisher sites;
obtaining merchant information including value information corresponding to the plurality of publisher content items;
using a processor, the publisher information, and the merchant information to generate a set of listings for transfer to the plurality of publisher sites, the set of listings each being ranked taking into account the value information of the merchant information; and
allocating a merchant portion of revenue to publishers of the plurality of publisher sites, where the merchant portion of revenue corresponds to the value information of the merchant information.

2. The method as claimed in claim 1 wherein obtaining the publisher information includes providing an application programming interface (API) for the plurality of publisher sites.

3. The method as claimed in claim 1 wherein the publisher information includes item or product information corresponding to registered items or products.

4. The method as claimed in claim 1 wherein the value information of the merchant information includes merchant bid information corresponding to bids submitted by merchants on a per-item basis.

5. The method as claimed in claim 1 wherein generating a set of listings for transfer to the plurality of publisher sites includes matching keywords against content in a set of listings.

6. The method as claimed in claim 1 wherein ranking the set of listings includes sorting the set of listings taking into account the bids, corresponding to each listing, submitted by merchants.

7. The method as claimed in claim 1 wherein the merchant portion of revenue is allocated based on impressions or conversions of the set of listings on the plurality of publisher sites.

8. The method as claimed in claim 1 wherein the merchant portion of revenue is allocated based on impressions or conversions of the set of listings on the plurality of publisher sites and based on the value information of the merchant information, which includes merchant bid information corresponding to bids submitted by merchants on a per-item basis.

9. A system, comprising:
a processor;
a database, in data communication with the processor, for storage of publisher information, merchant information, and listings for transfer to a plurality of publisher sites; and
an ad network, executable by the processor, to obtain publisher information corresponding to a plurality of publisher content items from a plurality of publisher sites; to obtain merchant information including value information corresponding to the plurality of publisher content items; to use the publisher information and the merchant information to generate a set of listings for transfer to the plurality of publisher sites, the set of listings each being ranked taking into account the value information of the merchant information; and to allocate a merchant portion of revenue to publishers of the plurality of publisher sites, where the merchant portion of revenue corresponds to the value information of the merchant information.

10. The system as claimed in claim 9 wherein the ad network being further configured to obtain the publisher information via an application programming interface (API) for the plurality of publisher sites.

11. The system as claimed in claim 9 wherein the publisher information includes item or product information corresponding to registered items or products.

12. The system as claimed in claim 9 wherein the value information of the merchant information includes merchant bid information corresponding to bids submitted by merchants on a per-item basis.

13. The system as claimed in claim 9 wherein the ad network being further configured to generate a set of listings for transfer to the plurality of publisher sites by matching keywords against content in a set of listings.

14. The system as claimed in claim 9 wherein the ad network being further configured to rank the set of listings by taking into account the bids, corresponding to each listing, submitted by merchants.

15. The system as claimed in claim 9 wherein the merchant portion of revenue is allocated based on impressions or conversions of the set of listings on the plurality of publisher sites.

16. The system as claimed in claim 9 wherein the merchant portion of revenue is allocated based on impressions or conversions of the set of listings on the plurality of publisher sites and based on the value information of the merchant information, which includes merchant bid information corresponding to bids submitted by merchants on a per-item basis.

17. A non-transitory machine-useable storage medium embodying instructions which, when executed by a machine, cause the machine to:
obtain publisher information corresponding to a plurality of publisher content items from a plurality of publisher sites;
obtain merchant information including value information corresponding to the plurality of publisher content items;
use a processor, the publisher information, and the merchant information to generate a set of listings for transfer to the plurality of publisher sites, the set of listings each being ranked corresponding to the value information of the merchant information; and
allocate a merchant portion of revenue to publishers of the plurality of publisher sites, where the merchant portion of revenue corresponds to the value information of the merchant information.

18. The machine-useable storage medium as claimed in claim 17 wherein the instructions being further configured to provide an application programming interface (API) for the plurality of publisher sites.

19. The machine-useable storage medium as claimed in claim 17 wherein the publisher information includes item or product information corresponding to registered items or products.

20. The machine-useable storage medium as claimed in claim 17 wherein the value information of the merchant information includes merchant bid information corresponding to bids submitted by merchants on a per-item basis.
